(19) United States
(12) Patent Application Publication
(10) Pub. No.: US 2016/0036932 A1
(43) Pub. Date: Feb. 4, 2016

(54) METHOD AND SYSTEM FOR DETERMINING USER LOCATION

(71) Applicant: YANDEX EUROPE AG, Luzern (CH)

(72) Inventor: Denis Aleksandrovich EVDOKIMOV, Moscow (RU)

(21) Appl. No.: 14/866,027

(22) Filed: Sep. 25, 2015

Related U.S. Application Data
(63) Continuation of application No. PCT/IB2014/065218, filed on Oct. 10, 2014.

(30) Foreign Application Priority Data
Apr. 9, 2014 (RU) 2014113677

(51) Int. Cl. H04L 29/08

(52) U.S. Cl. CPC H04L 67/22; H04L 67/18; H04L 67/02

(57) ABSTRACT

There is disclosed a method of determining a user location based on web service session information. The method is executable at a server. The method comprises (i) based on the indication of the user interaction within the first modifiable component of the first web service, determining a first location-indicating parameter, the first location-indicating parameter being suggestive of a first user location of interest; (ii) based on the indication of the user interaction within the second modifiable component of the second web service, determining a second location-indicating parameter, the second location-indicating parameter being suggestive of the first location of interest; (iii) determining a user current location, at least in part based on the first location-indicating parameter determined and the second location-indicating parameter; and (iv) providing the user with the future web service session, the future web service session having a modifiable component having been modified by the server based on the user current location.

### CROSS-REFERENCE

The present application claims priority to Russian Patent Application No. 2014113677, filed Apr. 9, 2014, entitled “A METHOD AND SYSTEM FOR DETERMINING USER LOCATION” and is a continuation of PCT/IB2014/065218 filed on Oct. 10, 2014, entitled “METHOD AND SYSTEM FOR DETERMINING USER LOCATION” the entirety of which are incorporated herein.

### FIELD

The present technology relates to methods of determining a user location, in general, and specifically to a method and a system for determining user location based on a user interaction with a web service.

### BACKGROUND

A typical user has a multitude of communication devices available to him for accessing the Internet to potentially satisfy various needs for information or content. These communication devices include (but are not limited to) desktops, laptops, smartphones, tablets, just to name a few. When a particular user accesses to the Internet he\she is looking to solve a particular problem. Various web sites and web services provide thousands of different tools to potentially achieve the user's goals.

Different web resources are built to address a different user intent. For example, some web resources allow the user to browse latest news. Other web resources, allow the user to determine the most convenient driving route between Point A and Point B. Irrespective of the content of a given web resource, most web resources have a feature that can be modified or amended to make the user experience with the web resource a better one. Some of these features include, but are not limited to: a preferred language in which to present the information, the most convenient font size, the most relevant information provided by default and so on.

Some of these features can be conveniently modified, based on the knowledge of the user current location (or, alternatively, another location associated with the user—such as a frequent travel spot or a location of a second home, for example). Based on the knowledge of the user's location preferences the given web resource (or a web service associated with the given web resource) can provide more targeted information or an overall a more user-friendly browsing experience for the given user.

Several techniques have been developed in the prior art to determine user location. For example, user location can be approximated based on the Internet Protocol (IP) address associated with the user's electronic device that is used by the user to access the Internet.

Another known approach, specifically applicable, where a user uses a wireless electronic device with Global Positioning System (GPS) capabilities, user's location can be determined based on GPS information associated with the user position.

In another known solution, disclosed in the U.S. Pat. No. 8,301,369, granted to Myllymaki et al. teaches a method of locating a user based on his\her search queries. More specifically, Myllymaki et al teach a position detection apparatus that includes a storage unit for storing map information including road information; a detection unit for detecting information for calculating an absolute position of a moving object; a position calculation unit for calculating the absolute position of the moving object and an error variance relating to an error of the moving object from the detected information; a read-out unit for reading out from the storage unit the road information of a road relating to the calculated absolute position; an existence probability calculation unit for calculating an existence probability of the moving object existing on the road from the absolute position, the error variance, and the read-out road information; a selection unit for selecting a position whose existence probability is maximum out of the calculated existence probability; and a map-matching processing unit for making the selected position a position of the moving object on the road.

### SUMMARY

It is an object of the present technology to ameliorate at least some of the inconveniences present in the prior art.

According to embodiments of the present technology, there is provided a method of determining a user location based on web service session information. Generally speaking, the method can be implemented for determining the user's current location for further customizing a web service modifiable component in accordance to the user's current location.

According to a first broad aspect of the present technology, there is provided a method of determining a user location, the method executable at a server. The method comprises: receiving a request from a user for a first web service session, the first web service session having a first modifiable component based on the user location; appreciating an indication of a user interaction with the first modifiable component within the first web service session; based on the indication of the user interaction within the first modifiable component, determining a first location-indicating parameter, the first location-indicating parameter being suggestive of a first user location of interest; receiving a request from a user for a second web service session, the second web service session having a second modifiable component based on the user location; appreciating an indication of a user interaction with the second modifiable component within the second web service session; based on the indication of the user interaction within the second modifiable component, determining a second location-indicating parameter, the second location-indicating parameter being suggestive of the first location of interest; receiving a request from the user for a third web service session; determining a user current location associated with the third web service session, at least in part based on the first location-indicating parameter determined in association with the first web service session and the second location-indicating parameter determined in association with the second web service session; and providing the user with the third web service session, the third web service session having a third modifiable component, the third modifiable component having been modified by the server based on the user current location.

In some implementations of the method, the user interaction with the first modifiable component within the first web service session is a first user interaction. The method further comprises: appreciating an indication of a second user interaction with the first modifiable component within the first web service session; based on the indication of the second user interaction within the first modifiable component, determining a third location-indicating parameter, the third location-indicating parameter being suggestive of a second user location of interest.

In some implementations of the method, the user interaction with the first modifiable component within the first web service session is a first user interaction further comprising, prior to the determining the user current location, reconciling the first location-indicating parameter and the third location-indicating parameter.

In some implementations of the method, the reconciling comprises (i) assigning a respective score point to each one of the first location-indicating parameter and the third location-indicating parameter, and (ii) comparing the respective score points to determine which one of the first location-indicating parameter and the third location-indicating parameter is the most indicative of the user current location.

In some implementations of the method, the user interaction with the first modifiable component within the first web service session is a first user interaction further comprising, prior to the determining the user current location, reconciling at least two of the first location-indicating parameter, the second location-indicating parameter and the third location-indicating parameter.

In some implementations of the method, prior to the determining the user current location, the reconciling comprises (i) assigning a respective score point to the at least two of the first location-indicating parameter, the second location-indicating parameter and the third location-indicating parameter, and (ii) comparing the respective score points to determine which one of the first location-indicating parameter, the second location-indicating parameter and the third location-indicating parameter is the most indicative of the user current location.

In some implementations of the method, the user is associated with authorization information, and the method further comprises storing the first location-indicating parameter and the second location-indicating parameter in association with the authorization information.

In some implementations of the method, the authorization information comprises a log in credential for at least one of the first web service session and the second web service session and the third web service session.

In some implementations of the method, the first web service session comprises a map service, and the first modifiable component comprises a geographical location within the map service and the user interaction with the first modifiable component comprises selecting the geographical location.

In some implementations of the method, the first web service session comprises a cloud storage service, and the first modifiable component comprises an upload link to a cloud storage server used for upload, the cloud storage server having a geographical location, and the user interaction comprises initiating upload to the cloud storage server and the first location-indicating parameter is based, at least in part, on the geographical location of the cloud storage server.

In some implementations of the method, the first web service session comprises a web site, the website having a content portion associated with a geographical location, and the first location-indicating parameter is based, at least in part, on the geographical location associated with the content portion of the site.

In some implementations of the method, the first web service session comprises a weather forecast service and the determining the first location-indicating parameter is based on a geographical location of the weather forecast for a region being viewed by the user.

In some implementations of the method, the first web service session comprises a web search service and the determining the first location-indicating parameter is based on a geographical location associated with a web search query, the web search query is requested by the user.

In some implementations of the method, the first web service session comprises a delivery service and the determining the first location-indicating parameter is based on a geographical location of the delivery request being booked by the user.

In some implementations of the method, the user location information comprises at least one of an address, a postal code, a map, GPS coordinates, directions, a time zone, a local language.

According to another broad aspect of the present technology, there is provided a server comprising non-transient computer-readable medium storing computer-readable instructions, the instructions for causing the server to be configured to receive a request from a user for a first web service session, the first web service session having a first modifiable component based on the user location; appreciate an indication of a user interaction with the first modifiable component within the first web service session; based on the indication of the user interaction within the first modifiable component, determine a first location-indicating parameter, the first location-indicating parameter being suggestive of a first user location of interest; receive a request from a user for a second web service session, the second web service session having a second modifiable component based on the user location; appreciate an indication of a user interaction with the second modifiable component within the second web service session; based on the indication of the user interaction within the second modifiable component, determine a second location-indicating parameter, the second location-indicating parameter being suggestive of the first location of interest; receive a request from the user for a third web service session; determine a user current location associated with the third web service session, at least in part based on the first location-indicating parameter determined in association with the first web service session and the second location-indicating parameter determined in association with the second web service session; and provide the user with the third web service session, the third web service session having a third modifiable component, the third modifiable component having been modified by the server based on the user current location.

According to another broad aspect of the present technology, there is provided a server comprising non-transient computer-readable medium storing computer-readable instructions, the instructions for causing the server to appreciate an indication of a second user interaction with the first modifiable component within the first web service session; based on the indication of the second user interaction within the first modifiable component, determine a third location-indicating parameter, the third location-indicating parameter being suggestive of a second user location of interest.

According to another broad aspect of the present technology, there is provided a server comprising non-transient computer-readable medium storing computer-readable instructions, the instructions are for causing the server to be further configured to, prior to determining the user current location, to reconcile the first locating parameter and the third locating parameter.

According to another broad aspect of the present technology, there is provided a server comprising non-transient computer-readable medium storing computer-readable instructions, the instructions are for causing the server to be further configured to, in order to reconcile the first locating parameter and the third locating parameter, to (i) assign a respective score point to each one of the first location-indicating parameter and the third location-indicating parameter, and (ii) compare the respective score points to determine which one of the first location-indicating parameter and the third location-indicating parameter is the most indicative of the user current location.

According to another broad aspect of the present technology, there is provided a server comprising non-transient computer-readable medium storing computer-readable instructions, the instructions are for causing the server to be further configured to, prior to determining the user current location, reconcile at least two of the first location-indicating parameter, the second location-indicating parameter and the third location-indicating parameter.

According to another broad aspect of the present technology, there is provided a server comprising non-transient computer-readable medium storing computer-readable instructions, the instructions are for causing the server to be further configured to, in order to reconcile at least two of the first location-indicating parameter, the second location-indicating parameter and the third location-indicating parameter, the server (i) assign a respective score point to the at least two of the first location-indicating parameter, the second location-indicating parameter and the third location-indicating parameter, and (ii) compare the respective score points to determine which one of the first location-indicating parameter, the second location-indicating parameter and the third location-indicating parameter is the most indicative of the user current location.

According to another broad aspect of the present technology, there is provided a server comprising non-transient computer-readable medium storing computer-readable instructions, the first web service session comprises a map service, and the first modifiable component comprises a geographical location within the map service and the user interaction comprises selecting the geographical location.

According to another broad aspect of the present technology, there is provided a server comprising non-transient computer-readable medium storing computer-readable instructions, the first web service session comprises a cloud storage service, and the first modifiable component comprises an upload link to a cloud storage server used for upload, the cloud storage server having a geographical location, and the user interaction comprises initiating upload to the cloud storage server and the first location-indicating parameter is based, at least in part, on the geographical location of the cloud storage server.

According to another broad aspect of the present technology, there is provided a server comprising non-transient computer-readable medium storing computer-readable instructions, the first web service session comprises a web site, the website having a content portion associated with a geographical location, and the first location-indicating parameter is based, at least in part, on the geographical location associated with the content portion of the site.

According to another broad aspect of the present technology, there is provided a server comprising non-transient computer-readable medium storing computer-readable instructions, the first web service session comprises a weather forecast service and the determining the first location-indicating parameter is based on a geographical location of the weather forecast for a region being viewed by the user.

According to another broad aspect of the present technology, there is provided a server comprising non-transient computer-readable medium storing computer-readable instructions, the first web service session comprises a web search service and the determining the first location-indicating parameter is based on a geographical location associated with a web search query, the web search query is requested by the user.

According to another broad aspect of the present technology, there is provided a server comprising non-transient computer-readable medium storing computer-readable instructions, the first web service session comprises a delivery service and the determining the first location-indicating parameter is based on a geographical location of the delivery request being booked by the user.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “communication device” is any computer hardware that is capable of running software appropriate to the relevant task at hand. Thus, some (non-limiting) examples of communication devices include personal computers (desktops, laptops, netbooks, etc.), smartphones, and tablets, as well as network equipment such as routers, switches, and gateways. It should be noted that a device acting as a communication device in the present context is not precluded from acting as a server to other client devices. The use of the expression “a communication device” does not preclude multiple communication devices being used in receiving/sending, carrying out or causing to be carried out any task or request, or the consequences of any task or request, or steps of any method described herein.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology as well as other aspects and further features thereof, reference is made to the following description which is to be used in conjunction with the accompanying drawings, where:

FIG. 1 is a schematic diagram of a system 100, the system 100 being suitable for implementing non-limiting embodiments of the present technology within a communications network environment, various components of the system 100 shown during a web service session initiation.

FIG. 2 depicts a diagram showing interactions within the system 100 of the present technology, various components of the system 100 shown during a web service session initiation.

FIG. 3 depicts a schematic diagram of certain components of the system 100 of FIG. 1, with various information exchanged there between during execution of the various routines of non-limiting embodiment of the present technology.

FIG. 4 depicts a block diagram of a method 400, method 400 being implemented in accordance with non-limiting embodiments of the present technology.

FIG. 5 depicts a table 500 maintained by a server 106 of FIG. 1, the table 500 maintaining a mapping of the user location-indicating parameters and the user's current location parameters within embodiments of the present technology.

FIG. 6 depicts a diagram illustrating an example general-purpose computer system on which the methods of the present technology and the system 100 can be implemented.

### DETAILED DESCRIPTION

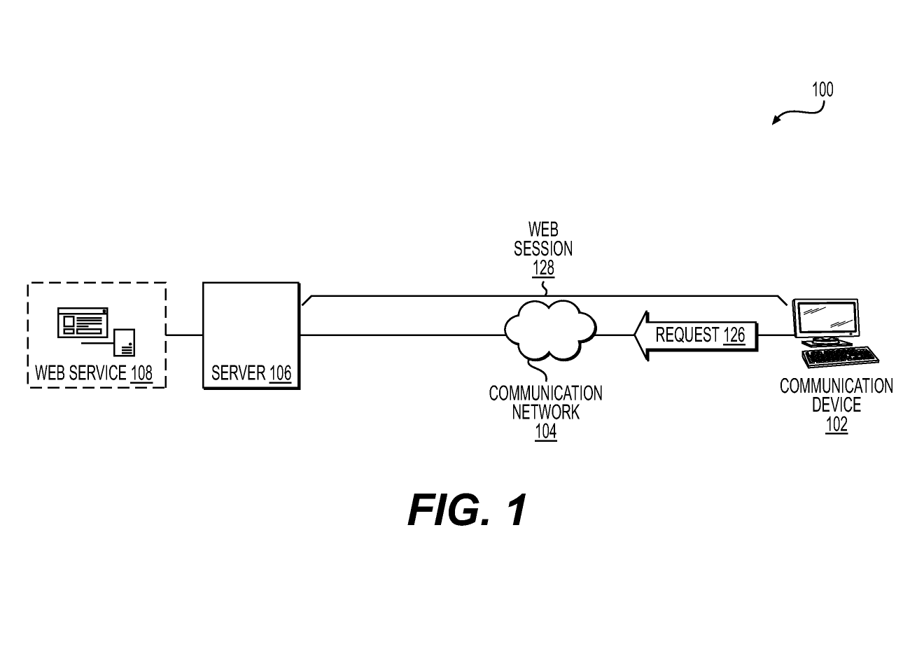

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The implementation of the communication device 102 is not particularly limited, but as an example, the communication device 102 may be implemented as a personal computer (desktops, laptops, netbooks, etc.), a wireless electronic device (a cell phone, a smartphone, a tablet and the like), as well as network equipment (a router, a switch, or a gateway). The general implementation of the communication device 102 is known in the art and, as such, will not be described here at much length. Suffice it to say that the communication device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over a communications network 104; and a processor coupled to the user input interface, the user output interface and the network communication interface, the processor being configured to execute various routines, including those described herein below. To that end the processor may store or have access to computer readable commands which commands, when executed, cause the processor to execute the various routines described herein.

Generally speaking, the communication device 102 allows a user (not depicted) to access a server 106. The communication device 102 can access the server 106 via the aforementioned communication network 104. To that end, the communication device 102 comprises hardware and/or software and/or firmware (or a combination thereof), as is known in the art, to execute a browser application. Generally speaking, the purpose of the browser application is to enable the user (not depicted) to access one or more web resources and/or one or more web services hosted by one or more web resources. The implementations of the browser application are well known to those of skill in the art and, as such, will not be described here at any length.

In some embodiments of the present technology, the server 106 can be implemented as a conventional computer server. In an example of an embodiment of the present technology, the server 106 can be implemented as a Dell™ PowerEdge™ Server running the Microsoft™ Windows Server™ operating system. Needless to say, the server 106 can be implemented in any other suitable hardware and/or software and/or firmware or a combination thereof. In the depicted non-limiting embodiment of present technology, the server 106 is a single server. In alternative non-limiting embodiments of the present technology, the functionality of the server 106 may be distributed and may be implemented via multiple servers (not depicted).

The implementation of the server 106 is well known. However, briefly speaking, the server 106 comprises a communication interface (not depicted) structured and configured to communicate with various entities (such as the communication device 102, for example and other devices potentially coupled to the communications network 104) via the communications network 104. The server 106 further comprises at least one computer processor (not depicted) operationally connected with the communication interface and structured and configured to execute various processes to be described herein.

In some embodiments of the present technology, the communication network 104 is the Internet. In alternative non-limiting embodiments, the communication network 104 can be implemented as any suitable local area network (LAN), wide area network (WAN) or the like. It should be expressly understood that implementations for the communication network 104 are for illustration purposes only. The communication network 104 can further be using a wireless connection with the communication device 102, for non-limiting example, a 3G network, a 4G network, a Wireless Fidelity (WI-FI)™, Bluetooth™ and the like. In other embodiments the communication network 104 can use a connection with wire devices (wire devices are implementations of the communication device 102) via Ethernet based connection.

Within some embodiments, the server 106 can access a web service 108. Generally speaking, the web service 108 is an application executed by or via the server 106, which application is geared towards addressing one or more of user's needs or problems. For example, a map service, being an example of the web service 108, is geared to solving a user problem of determining a particular route from Point A to Point B. Generally, the user accesses the web service 108 by accessing or logging into a pre-defined web resource hosted on the server 106. For example, if a given user wanted to access a Yandex map service, the user would type the following URL into the browser application: http://maps.yandex.ru/, as an example only.

The exact nature of the web service 108 is not limited and teachings presented herein can be applied to various types of the web service 108, only an exemplary list of which is presented herein below.

In some implementations of the present technology, merely as an illustration and not a limitation, the web service 108 can be a map service, a weather service, a general search engine service, a vertical search engine service, a web mail service, a cloud storage service, a delivery service and the like.

More specifically, the map service can be a service, providing maps and routes, for example Yandex™ Maps or Google™ Maps. The weather service can be a weather forecast service, for example Yandex Weather™ service. The general search engine can be a general-purpose search engine, for example a web search service, such as Yandex™ search or Google™ Search. The vertical search engine, such as Yandex Vertical Search engine provides different verticals in respect of the type of content, the user is searching for. A different vertical is provided for different type of content. A search for images can be provided with an image search vertical and a search for music can be provided with a music search vertical.

The web mail service can be, in general, any type of a web mail service, for instance Yandex™ Mail or Gmail™ services. The cloud storage service can be a cloud based service for storing and sharing data, for instance Dropbox™, Microsoft™ SkyDrive™ cloud service or Yandex™ Disk™ service. The delivery service can be a service for shopping, such as Amazon™ on-line store or Yandex™ Market service.

It should be expressly understood that any number of additional or alternative services can be present in addition or in lieu of the examples provided herein.

In order to start using one of the aforementioned services, the user can initiate a web session 128 using the communication device 102. More specifically, the user can interface with the aforementioned web browser (type in an URL, select a hyperlink or the like). The user's interaction with the communication device 102 can cause the communication device 102 to generate a request 126 and to send the request 126 via the communication network 104 to initiate a web service session 128. A type and form of the request 126 will depend on the nature of the web service session 128 being requested by the user. What follows are just some non-limiting and non-exclusive examples of how the request 126 can be implemented.

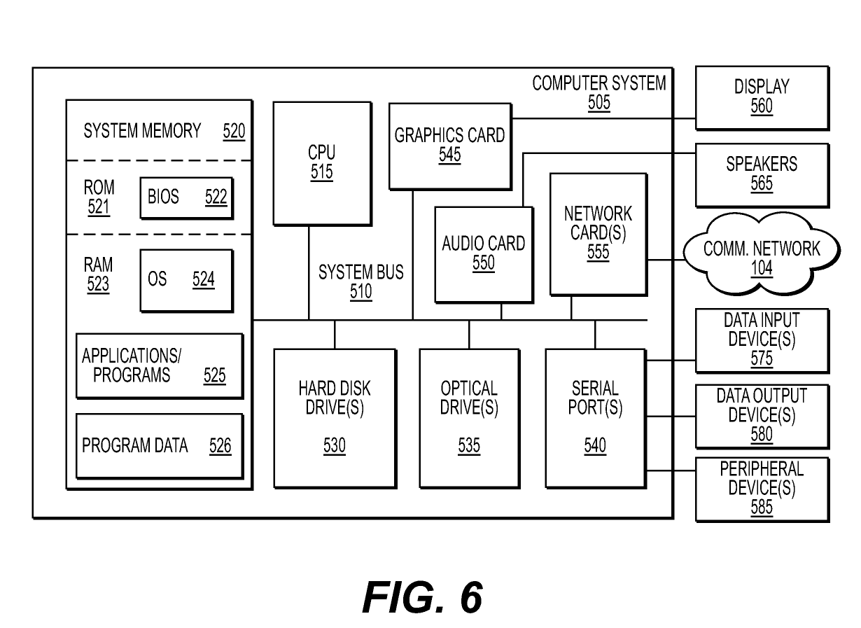

The request 126 can comprise an indication of a route request in the map service, for example an address request in the Yandex™ maps service. The user can input the address (such as a “from” and “to” address or the like), for example, via a data input devices 575 (shown in FIG. 6) of the communication device 102, such as a keyboard or a touch screen interface. The communication device 102 can capture the so-inputted address and transmit the request 126 containing the address information via the communication network 104 to the web service 108

The request 126 can comprise a weather forecast request in the weather service, such as Yandex™ Weather service. The user can input a name of the city, for which the user is desirous of seeing a weather forecast. The communication device 102 can capture the so-inputted city name and transmit the request 126 containing the city name information via the communication network 104 to the web service 108.

In an alternative embodiment, the request 126 can comprise a search input in the general search engine, for example a search request in the Yandex™ Search engine or a search request in the vertical search engine. In this embodiment, the user can input the search query into the aforementioned browser application. The communication device 102 can be configured to capture the search query and to transmit the request 126 containing the search query to the web server 108 via the communication network 104.

The request 126 can comprise an email list refresh request in the web mail service, for example a request to retrieve new emails in the Yandex™ mail service. The user can cause the communication device 102, by interacting with the communication device 102, to send the request 126 containing a request for an email list refresh to the web mail service.

The request 126 can comprise a request to use an upload link or to download a file from the cloud storage service, such as Yandex™ Disk service or Microsoft™ SkyDrive™ service. In this embodiment, the request 126 can contain web links or application instructions, for example, instructions for Yandex Disk™ to start uploading a file from the communication device 102 or downloading a file to the communication device 102.

In an alternative embodiment, the request 126 can comprise an authorization for a delivery (such as a delivery address) from a delivery service, such as Amazon™ on-line store or Yandex™ market on-line store. In this embodiment, the user can cause the communication device 102, by interacting with the communication device 102, to send the request 126 to the delivery service for authorization within the delivery service.

Additionally or alternatively, the request 126 can contain authorization credentials for authorization of the user in the web service 108, a log in into the web service 108, or a launch of the web service 108. The user can cause the communication device 102, to send a request 126 for authorization in the web service 108 to the server 106 via the communication network 104. The server 106 is configured to receive the request 126 via the communication network 104.

The server 106 can appreciate the request 126, sent by the communication device 102 via the communication network 104 and grant an access to the web service 108 based on user's input information, for example a login and authorization information (the login and authorization information can be a part of the request 126), inputted by the user through data input devices 575 (shown in FIG. 6) of the communication device 102, such as a keyboard or a touch screen interface. Once the access is granted, the server 116 can establish the web service session 128 with the communication device 102.

After such the web service session 128 is established, the user may execute one or more interactions within the web service session 128 with the web service 108. The one or more user interactions with the web service 108 can cause the server 106 to change the interface of the web service 108 (namely, at least a portion the interface of the web service 108 as displayed on the communication device 102).

For example, let's assume a user is using a weather service and the user has been presented with a weather forecast associated with a predefined city (predefined city can be selected by the server 106 based on, for example, user-set preferences with the weather service or various techniques described in the Background section or otherwise known in the prior art).

The user may change her request to see the weather forecast for a city different from the predefined city being shown to her. The user's interaction of changing the predefined city name via the user interface of the communication device 102 can cause the communication device 102 to send, via the communication network 104, to the server 106 a request to change a portion of the weather service's interface. The server 106 can appreciate the changes, requested by the user via the communication device 102, and send back via the communication network 104 to the communication device 102 a request to trigger change interface on the communication device 102. User can further operate with the changed interface of the weather service via the communication device 102, for example preview the weather forecast for the changed city via the interface of the weather service.

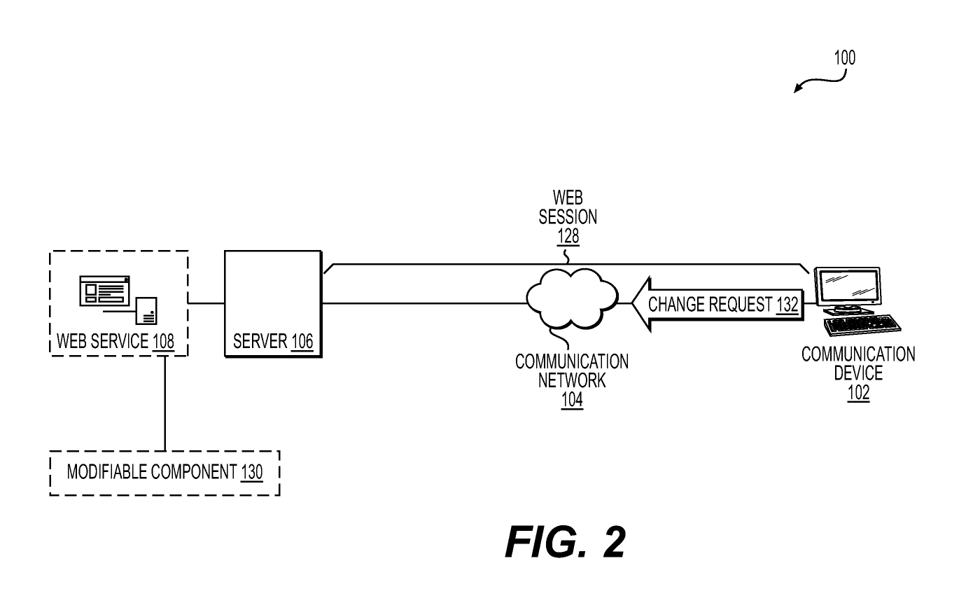

To illustrate and with reference to FIG. 2, the web service 108 can have a modifiable component 130. The modifiable component 130 can be a changeable part of the web service 108. For the sake of example, the above-referenced map section of the weather services that can be changed to show weather forecast from that for the predefined city to a user-selected city can be deemed to be the modifiable component 130.

In some embodiments of the present technology, a given one web service 108 can have more than one modifiable components 130, each one of the more than one modifiable component 130 not necessarily being of the same type as a different one of the more than one modifiable component 130. Generally speaking, any portion of the web services 108 that can change at least partially based on the geographical information associated with the communication device 102 (or selected by the user or otherwise associated with the user) can be deemed to be the modifiable component 130 within the meaning of this disclosure.

For example, the modifiable component 130 can be a section of a map within the map service. The user can interact with the map section within the map service by selecting a section of his\her interest at the then moment; the selection being representative of the map section the user is desirous of viewing.

In another example, the modifiable component 130 can be a city name for the weather service (as has been previously described). The user can interact with the city section within the weather service by selecting a city name of his\her interest at the then moment.

In another example, the modifiable component 130 can be a search results page (SERP) within the general search engine or a vertical for the vertical search engine. In the example the search results page (SERP) can be modified based on, at least partially, the geographical information of the user of the communication device 102. For example, the user situated in Canada can receive the SERP with ranked search results based at least partially on the factor that the search request was submitted from Canada.

In another example, the modifiable component 130 can be a visual appearance scheme of an e-mail message in an e-mail service. For example, when the user requests her e-mail message, the preselected visual appearance scheme of the e-mail message being modified based on the geographical location of the user.

It is believed that those skilled in the art will be able to appreciate other implementation details for a modifiable component 130 of the web services 108.

As part of using the web service 108, the user can perform a user interaction with the modifiable component 130. Examples of the user interactions include but are not limited to (depending on the nature of the web service 108): (i) moving a map section in the map service via the user interface means of the communication device 104, (ii) changing the city name for the weather service through data input devices 575 (shown in FIG. 6) of the communication device 104, and (iii) selecting an upload link from the communication device 102 via the user interface means of the communication device 102 and the like.

In some embodiments of the present technology, responsive to the user's interaction with the modifiable component 130, the communication device 102 transmits to the server 106 via the communication network 104, a change request 132, the change request 132 including instructions for the server 106 to change the web service's 108 modifiable component 130. The server 106 receives the change request 132 via the communication network 104 and sends back the changed data for the reused version of modifiable component 130 to be displayed to the user via the communication device 102.

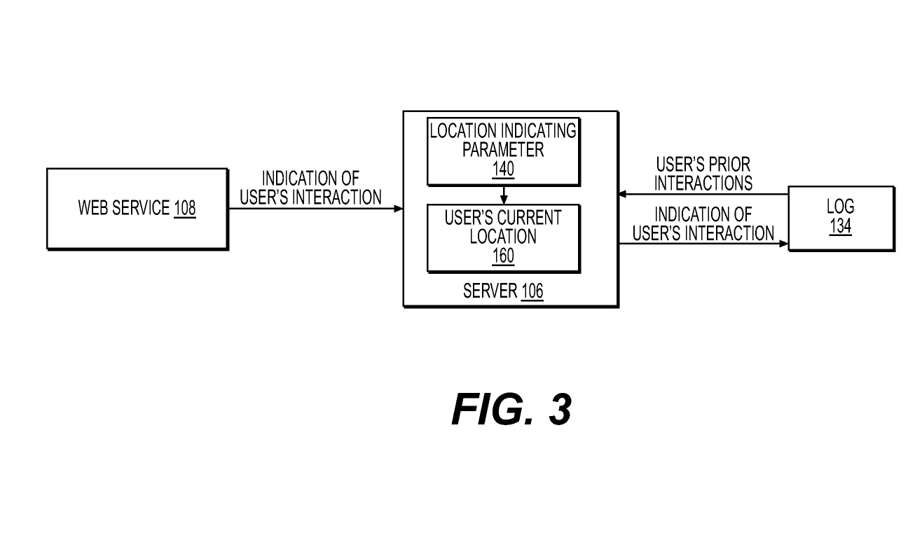

As is schematically shown in the FIG. 3, within some embodiments of the present technology, the server 106 can store an indication of the user interaction and/or at a later point of time access information representative of the user's prior interactions with the web service 108. The information about the user's prior interactions can be stored in and retrieved from by the server 106 in a log 134.

The log 134 can store information associated with the user's prior interactions with the modifiable component 130 within a previous instance of the web service 108. In some alternative implementations, the server 106 can store the log 134 locally. Additionally or alternatively, the server 106 can share the log 134 with other servers (not depicted). Additionally or alternatively, the server 106 can send the log 134 via the communication network 104 to the communication device 102. The communication device 102 can store the received log 134 locally on the communication device 102 internal system memory 520 means (shown in FIG. 6). The system memory 520 (shown in FIG. 6) that stores the log 134 can be a computer readable medium (e.g., Random Access Memory (RAM), hard disk drive, magnetic or optical drive, a diskette, a flash disk drive or the like). The communication device 102 can send the log 134 to another server (not depicted) for further operations.

More specifically, in some embodiments of the present technology, the server 106 can store the location-indicating parameter 140 during the given user's interaction in the log 134. In some embodiments of the present technology, the server 106 can associate the location-indicating parameter 140 with the user's authorization information. For example, the server 106 can associate the location-indicating parameter 140 within the web service session 128 with a “log in” information of the user, the log in information for authenticating the user into the web service 108.

When the server 106 appreciates the indication of the user's interaction with the modifiable component 130, the server 106 can analyze the user's interaction with the modifiable component 130 in substantially real time. Alternatively, the server 106 can store the indication of the user's interaction with the modifiable component 130 in the log 134 for analysis later on. Alternatively or additionally, the server 106 can store the indication of the user's interaction with the modifiable component 130 in the log 134 for analysis later on (at which point it will become an indication of a prior user's interaction with them modifiable component 130) in combination with the then fresh indication of the user's interaction with the modifiable component 130.

The server 106 can analyze the user's interaction (or the user's prior interaction or a combination of the user's interaction and a plurality of user's prior interactions) with the modifiable component 130 with a view of determining a location-indicating parameter 140, the location-indicating parameter 140 being indicative of the user's location of interest; the location of interest is a geographical location about which the user may want to obtain information in the future. The location-indicating parameter 140 can comprise an address, a postal code, Global Positioning System (GPS) coordinates, directions, a time zone or the like.

The server 106 can analyze the user's interaction (or the user's prior interaction or a combination of the user's interaction and a plurality of user's prior interactions) in several ways. How the server 106 analyzes user interaction with the modifiable component 130 will be described using several non-limiting examples. More specifically, for the purpose of illustrating the above, several scenarios will be described of how the server 106 can determine the location-indicating parameter 140.

For instance, if the user changes the city name within the weather service from Boston to Chicago, the server 106 can determine that user associates his\her interests with Chicago during the given interaction. The server 106 can thus determine a location-indicating parameter 140, the location-indicating parameter 140 in the example being suggestive of Chicago as the user's location of interest.

As other examples, (i) moving a map section in the map service via the user interface means of the communication device 102 from a section of Paris to Berlin can lead the server 106 to determine user's location-indicating parameter 140 to be Berlin, (ii) changing the city name for the weather service via the user interface means of the communication device 102 from Paris to Berlin can lead the server 106 to determine user's location-indicating parameter 140 to be Berlin, (iii) entering a new search query for the general search engine via the user interface means of the communication device 102, the search query containing Berlin as part of the search term (for example a search query “Starbucks® nearby The Brandenburg Gate, Berlin” can lead the server 106 to determine user's indicating parameter 140 to be Berlin.

In yet alternative embodiments, wherein the web service 108 can be embodied in a web site, the website having a content portion that can be modified (or otherwise associated) with a geographical location. Within these embodiments, the location-indicating parameter can be based, at least in part, on the geographical location associated with the content portion of the site.

It should be expressly understood that any number of additional or alternative services can be present in addition or in lieu of the examples provided herein.

In some embodiments of the present technology, the user location-indicating parameter 140 can be used to determine a user's current location 160. The current location 160 information can comprise an address, a postal code, Global Positioning System (GPS) coordinates or the like.

As an illustration, let it be assumed that the user was looking for the weather forecast within the weather service for Chicago, and the user was looking for a Starbucks™ café in Chicago via the general search service and was looking at a particular area in Chicago on the map within the map service during a single instance of the web service session 128. The server 106 can determine three respective location-indicating parameter 140 during the single web service session 128, each one being “Chicago”. Based on the three instances of the location-indicating parameter 140, the server 106 can deduct the user's current location 160 to be Chicago. In some embodiments of the present technology, the server 106 can further store the deducted user's current location 160 in the log 134, in association with a user profile.

In the above example, all three instances of the location-indicating parameter 140 were indicating of the same current location 160. This may not be the case in all scenarios. As such, in some embodiments, as part of the server 106 determining the user's current location 160 the server 106 may need to reconcile one or more location-indicating parameters 140 based on the user's interaction or the user's prior interactions with the web service 108, which may be within the same or a different respective web service 108.

For instance, the server 106 can appreciate a first indication of the user's interaction with the map service, providing the location-indicating parameter 140 to be Chicago. If another service, such as weather service provides to the server 106 a second location-indicating parameter 140 to be Chicago, and the general search service provides a third location-indicating parameter 140 to be Chicago, similar to the above example, the server 106 can determine the user's current location 160 to be Chicago.

However, if yet another web service 108, say, the web mail service provides a fourth location-indicating parameter 140 to be Boston, the server 106 needs to reconcile the first location-indicating parameter 140, the second location-indicating parameter 140, the third location-indicating parameter 140 and the fourth location-indicating parameter 140. In some embodiments, the server 106 can reconcile the first location-indicating parameter 140, the second location-indicating parameter 140, the third location-indicating parameter 140 and the fourth location-indicating parameter 140 based on statistical majority. Using this example, the server 106 can determine, as the result of the reconciliation, the user's current location 160 to be “Chicago” (despite the fourth location-indicating parameter 140 being indicative of Boston).

In another example scenario, the server 106 can reconcile a group of six location-indicating parameters 140: three of the group being indicative of Chicago and three of the group being indicative of Boston. In that case the server 106 may not have enough information to deduct the user current location 160. The server 106 can further await additional location-indicating parameters 140 to reconcile and to provide the final determination of the user's current location 160. When such additional location-indicating parameters 140 becomes available through further user interaction with one or more of the modifiable components 130, the server 106 can retrieve, from the log 134, the indication of the previous location-indicating parameters 140 and to perform the reconciliation.

In some embodiments of the present technology, in order to determine the current location 160, during the reconciling of the location-indicating parameters 140 the server 106 can assign a respective score point 162 to the location-indicating parameter 140. In some embodiments of the present technology, the respective score point can be indicative of how likely that a given location-indicating parameter 140 is indicative of the user's current location 160.

To provide a few examples, the server 106 can assign a respective score point 162 for the location-indicating parameter 140 in association with the user's interaction with the map service. The server 106 can assign another respective score point 162 to the location-indicating parameter 140 in association with the user's interaction with the weather service. After assigning the respective score points 162 to the location-indicating parameter 140 in association with the user's interaction with the web services 108 the server 106 can provide a determination of the most relevant results in respect of the then current user's interaction, using the so-assigned respective score points 162 based on the above-determined respective score points 162.

In some embodiments of the present technology, the respective score point 162 can have a numerical value. For example, the server 106 can use a decimal system for denoting the respective score point 162. In one particular example, the larger the numerical value of the respective score point 162 stands for a more significant respective score point 162. For example, the server 106 can assign a respective score point 162 on a scale of 1 to 100, where 1 is the least statistically significant and 100 is the most statistically significant respective score point 162.

In some embodiments of the present technology, the server 106 can determine several location-indicating parameter 140 and respective score points 162, based on several user interactions with a single web service 108 within a single web session 128.

In other embodiments of the present technology, the server 106 can assign several location-indicating parameters 140 and respective score points 162 for each of the multiple web services 108 within a single web service session 128 (i.e. user accessing a weather service, a map service and a webmail service in a single instance of the web server session 128).

In other implementation of the present technology, the server 106 can assign several location-indicating parameters 140 and respective score points 162 for one web service 108 within the multiple web service session 128 (i.e. user accessing a weather service in multiple web server sessions 128, distributed over time, for example).

Put another way, the server 106 can assign several location-indicating parameters 140 and respective score points 162 for the one web service 108 during several user's interactions within the same web service 108 or during several user's interactions within the same web service session 128 or during several user's interactions within several web service sessions 128.

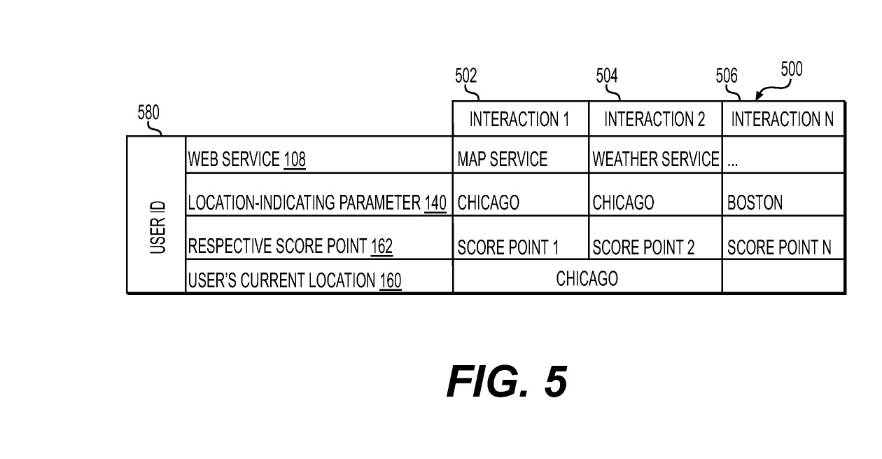

Finally, the server 106 can create a table 500 of respective score points 162 associated with respective web services 108 and the respective location-indicating parameters 140, a schematic diagram of which is shown in FIG. 5.

As is shown in the FIG. 5, the table 500 created by the server 106 can contain indications of the user's interactions within the web service 108, the respective location-indicating parameter 140, the respective score points 162 and the user's current location 160. The server 106 can populate the table 500 in the following order, as an example.

First Instance of Time

First, let's assume that the user interacts with a map service. The server 106 appreciates the user interaction and populates an indication of a first user interaction 502. Specifically, the server 106 populates the indication of the first user interaction 502 to read: <web service 108><map service>, <location-indicating parameter 140><Chicago>, <score point 162><score point 1>.

The server 106 then considers if it has enough information to make a determination of the user's current location 160. In this case, the server 106 does not have enough information, so it awaits for another indication of the user interaction with the modifiable component 130.

Second Instance of Time

Next, let's assume that the user interacts with a weather service. The server 106 appreciates the user interaction and populates an indication of a second user interaction 504. Specifically, the server 106 populates the indication of the second user interaction 504 to read: <web service 108><weather service>, <location-indicating parameter 140><Chicago>, <score point 162><score point 2>.

The server 106 then considers if it has enough information to make a determination of the user's current location 160. In this case, the server 106 may have enough information, so the server 106 populates the user current location 160 to be Chicago.

Third Instance of Time

The server 106 then may continue to monitor user interactions with one or more modifiable components 130. This can be done either because the server 106 does not have enough information to make a determination of the user's current location 160 or, as is the case with depiction of FIG. 5, in case it may be desirous to determine if the user's current location 160 may need to be updated.

Next, let's assume that the user interacts with an N-service. The server 106 appreciates the user interaction and populates an indication of an Nth user interaction 506. Specifically, the server 106 populates the indication of the Nth user interaction 506 to read: <web service 108><N service>, <location-indicating parameter 140><Location N>, <score point 162><score point N>.

The server then determines if the user's current location 160 may need to be updated (as has been described above) and, if the change is required, updated the user's current location 160 to <Location N>.

It is noted that the table 500 is stored in association with the User ID 580, which can be a username used by the user to log in into one or more of the web service 108.

In some embodiments of the present technology, the server 106 can further assign a relevancy weight to a given one of the various web services 108. For example, a weather service may be assigned a high relevancy weight than a map service. The higher relevancy weight may be indicative of the fact that one of the web services 108 can be a more reliable source of the user's current location 160 than another. In some embodiments of the present technology, the relevancy weight is determined based on empirical observations of which ones of the web services 108 provide more relevant indications of the user current location 160. In some embodiments, the relevancy weight is taken into account when determining the user current location 160 using the following equation:

User current location 160=Location_{A}*Location_{A} weight*Source_{A} weight+Location_{B}*Location_{B} weight*Source_{B} weight Equation 1

where,

Location A/Location B are respective indications of the location-indicating parameter 140;

Location A weight/Location B weight are respective score points 162 for the respective location-indicating parameters 140; and

Source A weight/Source B weight are respective relevancy weights of the respective web services 108.

Alternatively, the user current location can be calculated using the following equation:

$$User current location 160 = {\sum }_{x = A , B} ( {L}_{x} * {Lw}_{x} * {Sw}_{x} ) \qquad Equation 2$$

where,

Lₓ is the indication of the location-indicating parameter 140;

Lwₓ is the respective score point 162; and

Swₓ is the respective relevancy weight.

Within some embodiments of the present technology, the information about the current location 160 of the user can further be used by the server 106 to enhance the user experience within the future web service 108. For example, let us assume that the server 106 has determined the particular user's current location 160 and has stored it in the table 500. When the user decided to access another web service 108, the server 106 can have a modifiable component 130 associated with the other web service 108 to be modified using the indication of the user's current location 160 stored in the table 500.

By way of illustrative example, if the user decides to use a weather service at a point in time after the table 500 has been populated, the server 106 can cause the weather service to show a weather forecast for Chicago, as a default option. In other words, the server 106 can cause the modifiable component 130 of the weather service to be modified based on the indication of the user's current location 160.

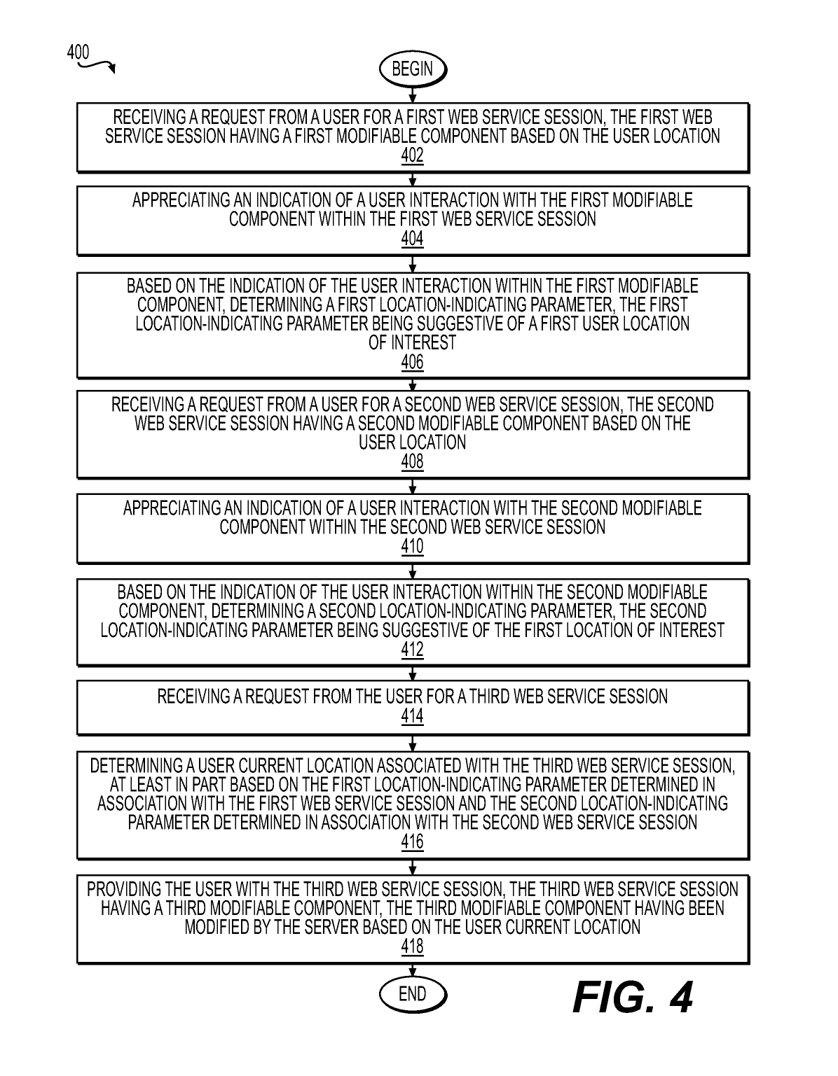

With reference to FIG. 4, there is depicted a flow chart of a method 400, the method 400 for determining the user current location 160. The method 400 can be conveniently executed by the server 106.

At step 402, the server 106 receives the request from a user for a first web service session 128 via the communication network 104. For the purposes of the illustration, it shall be assumed that the first web service session 128 is established by the server 106 during a map service interaction by the user. The first web service session 128 includes a first modifiable component 130. The first modifiable component 130 can be a changeable part of the web service 108. In the present illustration, the modifiable component 130 is a section of the map within a map service. In some embodiments, the modifiable component 130 shows an initial map section. The initial map section can be selected by the server 106 based on, for example, user-set preferences with the map service or various techniques described in the Background section or otherwise known in the prior art.

Next, at step 404, the server 106 appreciates an indication of a user interaction with the first modifiable component 130 within the first web service session 128. The server 106 can appreciate user's selection of a second map section different from the initial map section made during the receiving the request from the user for the first web service session 128 (at step 402).

As shown above, the server 106 can receive, via the communication network 104, the change request 132 from a communication device 102. The change request 132 includes inter alia instructions for the server 106 to change the map service modifiable component 130. The server 106 receives the change request 132 via the communication network 104 and sends back the changed data for the modifiable component 130 to be displayed to the user via the communication device 102.

Next, at step 406, the server 106, based on the indication of the user interaction within the first modifiable component 130, determines a first location-indicating parameter 140, the first location-indicating parameter 140 being suggestive of a first user location of interest. The location of interest is a geographical location about which the user may want to obtain information in the future. For example, if the user has changed the map view to Chicago (from whatever initial map view was), then the server 106 determines the first location-indicating parameter 140 to be Chicago. In a sense, the first location-indicating parameter 140 being “Chicago” is indicative of Chicago being a potential place of interest for the current user.

At step 408, the server 106 receives a request from the user for a second web service session 128 via the communication network 104, the second web service session 128 having a second modifiable component 130 based on the user location. Let it be assumed that the second web service session 128 is a weather service. The second web service session 128 can include the second modifiable component 130, which can be a city name for the weather service.

It is noted that in some embodiments, the second web service session 128 can be the first web service session 128.

At step 410, the server 106 appreciates an indication of the user interaction with the second modifiable component 130 within the second web service session 128. For example, the user can select a city for a weather forecast, the selected city different from the default city within the weather service.

At step 412, the server 106, based on the indication of the user interaction within the second modifiable component, determines a second location-indicating parameter 140, the second location-indicating parameter 140 being suggestive of a second user location of interest (which may be the same as the first user location of interest or a different one). The location of interest is a geographical location about which the user may want to obtain information in the future. For the purposes of the illustration, let it be assumed that the user has selected Chicago as a place to view the weather forecast for (either as an original query or a changed place from the default selected weather forecast place). The server 106 can therefore determine the second location-indicating parameter 140 to be “Chicago”.

At step 414, the server 106 receives a request from the user for a third web service session 128. For example, user can further want to use a map service.

Next, at step 416, the server 106 determines a user current location 160 associated with the third web service session 128, at least in part based on the first location-indicating parameter 140 determined in association with the first web service session 128 and the second location-indicating parameter 140 determined in association with the second web service session 128. As has been shown above, the server 106 has determined the first location-indicating parameter 140 to be “Chicago” and the second location-indicating parameter 140 to be “Chicago”. Based on the two location-indicating parameters 140 the server 106 can determine that the user current location 160 associated with the third web service session 128 is “Chicago”.

At step 418, the server 106 provides the user with the third web service session 128, the third web service session 128 having a third modifiable component 130, the third modifiable component 130 having been modified by the server 106 based on the user current location 160. The server 106 can modify the third modifiable component 130 prior to user interaction with the third modifiable component 130.

For example, where the third web service session 128 is a map service session, the server 106 can preselect the map section for the map service. When server 106 further provides the user with third web service session 128, the third web service session 128 having a third modifiable component 130, the third modifiable component 130 having been preselected based on the previously determined user's the then current location 160 (for example, by retrieving the user's current location 160 from the table 500).

For example, the third modifiable component 130 can have the city Chicago area preselected within map section within the map service, based on the then user's current location 160 determined by the server 106 to be Chicago.

In some embodiments of the method 400, the user may be desirous to obtain another weather forecast during the same or during a separate web service session 128. Thus, the user can select another city for the weather forecast within the weather forecast web service 108. The server 106 can receive another indication of the user interaction with web service 108 and determine a third location-indicating parameter 140. For example, if the user is looking within the weather service for another weather forecast for Boston, then the user can be interested in Boston. The server 106 can further recognize another location-indicating parameter 140 to be “Boston”.

As such, in an alternative embodiment of the present method 400, the server 106 can reconcile three location-indicating parameters 140: two of them being “Chicago” and one of them being “Boston”, as an illustration only. In this particular case, the server 106, by applying the reconciliation routines described above, can determine that the user's current location 160 is “Chicago”.

Needless to say, the server 106 may reconcile more than three location-indicating parameters 140 in order to determine the user's current location 160. In an illustrative example, the server 106 can reconcile a group of six location-indicating parameters 140: three of the group being “Chicago”, two of the group being “Boston” and one of the group being “Deli”. The server 106 can determine the user's current location 160 as Chicago for the particular example.

As another illustrative example, the server 106 can reconcile a group of six location-indicating parameters 140: three of the group being “Chicago” and three of the group being “Boston”. In that case the server 106, as part of reconciling, may not be able to execute a clear deduction of the user's current location 160 determination. The server 106 can, therefore, awaits an additional location-indicating parameters 140 to provide the final determination of the user's current location 160.

Next, the method 400 can either terminate or await for another indication of a user interaction or another modifiable component 130 to be pre-modified.

FIG. 6 depicts one example aspect of a computer system 505 that can be used to implement the disclosed systems and methods for determining a user location. The computer system 505 may be executed as, but not limited to, a personal computer, a notebook, tablet computer, a smart phone, a cell phone, a server, a router. As an example, the computer system 505 can be sued to embody the communication device 102. As shown, computer system 505 may include one or more hardware processors 515, memory 520, one or more hard disk drive(s) or flash disk drives or other type of drives 530, optical drive(s) 535, serial port(s) 540, graphics card 545, audio card 550 and network card(s) 555 connected by system bus 10. System bus 510 may be any of several types of bus structures including a memory bus or memory controller, a peripheral bus and a local bus using any of a variety of known bus architectures. Processor 515 may include one or more Intel® Core 2 Quad 2.33 GHz processors or other type of microprocessor.

System memory 520 may include a read-only memory (ROM) 521 and random access memory (RAM) 23. Memory 520 may be implemented as in DRAM (dynamic RAM), EPROM, EEPROM, Flash or other type of memory architecture. ROM 521 stores a basic input/output system 522 (BIOS), containing the basic routines that help to transfer information between the modules of computer system 5, such as during start-up. RAM 523 stores operating system 524 (OS), such as Windows® 7 Professional or other type of operating system (MAC OS\OS X®, Google Android®, iOS® (for smartphone implementation)), that is responsible for management and coordination of processes and allocation and sharing of hardware resources in computer system 505. Memory 520 also stores applications and programs 525. Memory 520 also stores various runtime data 526 used by programs 525 and applications (not depicted).

Computer system 505 may further include hard disk drive(s) and flash drives or other type of drives 530, such as SATA HDD, and optical disk drive(s) 535 for reading from or writing to a removable optical disk, such as a CD-ROM, DVD-ROM or other optical media. Drives 530 and 535 and their associated computer-readable media provide non-volatile storage of computer readable instructions, data structures, applications and program modules/subroutines that implement algorithms and methods disclosed herein. Although the exemplary computer system 505 employs magnetic and optical disks, it should be appreciated by those skilled in the art that other types of computer readable media that can store data accessible by a computer system 505, such as magnetic cassettes, flash memory cards, digital video disks, RAMs, ROMs, EPROMs and other types of memory may also be used in alternative aspects of the computer system 505.

Computer system 505 further includes a plurality of serial ports 540, such as Universal Serial Bus (USB), for connecting data input device(s) 575, such as keyboard, mouse, touch pad and other. Serial ports 540 may be also be used to connect data output device(s) 580, such as printer, scanner and other, as well as other peripheral device(s) 585, such as external data storage devices and the like. System 505 may also include graphics card 545, such as nVidia® GeForce® GT 240M or other video card (smartphone video chipset or a graphics card merged in the processor 515, for interfacing with a display 560 or other video reproduction device, such as touch-screen display. System 505 may also include an audio card 550 for reproducing sound via internal or external speakers 565. In addition, system 505 may include network card(s) 555, such as Ethernet, WiFi, GSM\LTE, Bluetooth or other wired, wireless, or cellular network interface for connecting computer system 505 to the communication network 104, such as the Internet.

In various aspects, the systems and methods described herein may be implemented in hardware, software, firmware, or any combination thereof. If implemented in software, the methods may be stored as one or more instructions or code on a non-transitory computer-readable medium. Computer-readable medium includes data storage. By way of example, and not limitation, such computer-readable medium can comprise RAM, ROM, EEPROM, CD-ROM, Flash memory or other types of electric, magnetic, or optical storage medium, or any other medium that can be used to carry or store desired program code in the form of instructions or data structures and that can be accessed by a processor of a general purpose computer, a smartphone or the like.

In the interest of clarity, not all of the routine features of the aspects are disclosed herein. It will be appreciated that in the development of any actual implementation of the technology, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure.

In some embodiments of the present technology, the web service session 128 can run on the server 106 or a separate server (not depicted). Moreover, the web service 108 can use single server, several servers, web services 108 can run simultaneously (e.g. several web services 108 can run at the same time), for example during the same web service session 128. For example, the general search engine can run simultaneously with the web mail service. During the establishing of the web service session 128, as it is explained above, the server 106 receives and sends instructions (being use examples of such instructions of the request 126) to operate the web service 108.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the technology concepts disclosed herein.

What is claimed is:

1. A method of determining a user location, the method executable at a server, the method comprising:
(a) receiving a request from a user for a first web service session, the first web service session having a first modifiable component based on the user location;
(b) acquiring an indication of a user interaction with the first modifiable component within the first web service session, the user interaction with the first modifiable component changing the first modifiable component, the user interaction creating an association with a first user location of interest;
(c) based on the indication of the user interaction within the first modifiable component, determining a first location-indicating parameter, the first location-indicating parameter being suggestive of the first user location of interest;
(d) receiving a request from a user for a second web service session, the second web service session having a second modifiable component based on the user location;
(e) acquiring an indication of a user interaction with the second modifiable component within the second web service session, the user interaction with the second modifiable component changing the second modifiable component, the user interaction creating an association with the first user location of interest;
(f) based on the indication of the user interaction within the second modifiable component, determining a second location-indicating parameter, the second location-indicating parameter being suggestive of the first user location of interest;
(g) receiving a request from the user for a third web service session;
(h) determining a user current location associated with the third web service session, at least in part based on the first location-indicating parameter determined in association with the first web service session and the second location-indicating parameter determined in association with the second web service session; and
(i) providing the user with the third web service session, the third web service session having a third modifiable component, the third modifiable component having been modified by the server based on the user current location.

2. The method of claim 1, wherein said user interaction with the first modifiable component within the first web service session is a first user interaction, the method further comprising:
acquiring an indication of a second user interaction with the first modifiable component within the first web service session;
based on the indication of the second user interaction within the first modifiable component, determining a third location-indicating parameter, the third location-indicating parameter being suggestive of a second user location of interest.

3. The method of claim 2, further comprising, prior to said determining the user current location, reconciling the first location-indicating parameter and the third location-indicating parameter with the objective of said determining the user current location.

4. The method of claim 3, wherein said reconciling comprises (i) assigning a respective score point to each one of the first location-indicating parameter and the third location-indicating parameter, and (ii) comparing said respective score points to determine which one of the first location-indicating parameter and the third location-indicating parameter is the most indicative of the user current location.

5. The method of claim 2, further comprising, prior to said determining the user current location, reconciling at least two of the first location-indicating parameter, the second location-indicating parameter and the third location-indicating parameter.

6. The method of claim 5, wherein said reconciling comprises (i) assigning a respective score point to the at least two of the first location-indicating parameter, the second location-indicating parameter and the third location-indicating parameter, and (ii) comparing said respective score points to determine which one of the first location-indicating parameter, the second location-indicating parameter and the third location-indicating parameter is the most indicative of the user current location.

7. The method of claim 1, wherein the user is associated with authorization information, and wherein the method further comprises storing said first location-indicating parameter and said second location-indicating parameter in association with the authorization information.

8. The method of claim 7, wherein said authorization information comprises a log in credential for at least one of the first web service session and the second web service session and the third web service session.

9. The method of claim 1, wherein said first web service session comprises a map service, and wherein said first modifiable component comprises a geographical location within the map service and wherein said user interaction with the first modifiable component comprises selecting said geographical location.

10. The method of claim 1, wherein said first web service session comprises a cloud storage service, and wherein said first modifiable component comprises an upload link to a cloud storage server used for upload, the cloud storage server having a geographical location associated therewith, and wherein said user interaction comprises initiating upload to the cloud storage server and wherein said first location-indicating parameter is based, at least in part, on the geographical location of the cloud storage server.

11. The method of claim 1, wherein said first web service session comprises a web site, the website having a content portion associated with a geographical location, and wherein said first location-indicating parameter is based, at least in part, on the geographical location associated with the content portion of the site.

12. The method of claim 1, wherein said first web service session comprises a weather forecast service and wherein said determining the first location-indicating parameter is based on a geographical location of the weather forecast for a region being viewed by the user.

13. The method of claim 1, wherein said first web service session comprises a web search service and wherein said determining the first location-indicating parameter is based on a geographical location associated with a web search query, the web search query is requested by the user.

14. The method of claim 1, wherein said first web service session comprises a delivery service and wherein said determining the first location-indicating parameter is based on a geographical location of the delivery request being booked by the user.

15. The method of claim 1, wherein the user location information comprises at least one of an address, a postal code, a map, GPS coordinates, directions, a time zone and a local language.

16. A server comprising non-transient computer usable information storage medium that includes computer-readable instructions, the instructions for causing the server to be configured to:
(a) receive a request from a user for a first web service session, the first web service session having a first modifiable component based on the user location;
(b) acquire an indication of a user interaction with the first modifiable component within the first web service session, the user interaction with the first modifiable component changing the first modifiable component, the user interaction creating an association with a first user location of interest;
(c) based on the indication of the user interaction within the first modifiable component, determine a first location-indicating parameter, the first location-indicating parameter being suggestive of the first user location of interest;
(d) receive a request from a user for a second web service session, the second web service session having a second modifiable component based on the user location;
(e) acquire an indication of a user interaction with the second modifiable component within the second web service session, the user interaction with the second modifiable component changing the second modifiable component, the user interaction creating an association with the first user location of interest;
(f) based on the indication of the user interaction within the second modifiable component, determine a second location-indicating parameter, the second location-indicating parameter being suggestive of the first user location of interest;
(g) receive a request from the user for a third web service session;
(h) determine a user current location associated with the third web service session, at least in part based on the first location-indicating parameter determined in association with the first web service session and the second location-indicating parameter determined in association with the second web service session; and
(i) provide the user with the third web service session, the third web service session having a third modifiable component, the third modifiable component having been modified by the server based on the user current location.

17. The server of claim 16, wherein said instructions are for causing the server to be further configured to:
acquire an indication of a second user interaction with the first modifiable component within the first web service session;
based on the indication of the second user interaction within the first modifiable component, determine a third location-indicating parameter, the third location-indicating parameter being suggestive of a second user location of interest.

18. The server of claim 17, wherein said instructions are for causing the server to be further configured, prior to determining the user current location, to reconcile the first locating parameter and the third locating parameter with the objective of said determining the user current location.

19. The server of claim 18, wherein said instructions are for causing the server to be further configured, in order to reconcile the first locating parameter and the third locating parameter, to (i) assign a respective score point to each one of the first location-indicating parameter and the third location-indicating parameter, and (ii) compare said respective score points to determine which one of the first location-indicating parameter and the third location-indicating parameter is the most indicative of the user current location.

20. The server of claim 17, wherein said instructions are for causing the server to be further configured, prior to determining the user current location, reconcile at least two of the first location-indicating parameter, the second location-indicating parameter and the third location-indicating parameter.

21. The server of claim 20, wherein said instructions are for causing the server to be further configured, in order to reconcile at least two of the first location-indicating parameter, the second location-indicating parameter and the third location-indicating parameter, to (i) assign a respective score point to the at least two of the first location-indicating parameter, the second location-indicating parameter and the third location-indicating parameter, and (ii) compare said respective score points to determine which one of the first location-indicating parameter, the second location-indicating parameter and the third location-indicating parameter is the most indicative of the user current location.

22. The server of claim 16, wherein said first web service session comprises a map service, and wherein said first modifiable component comprises a geographical location within the map service and wherein said user interaction comprises selecting said geographical location.

23. The server of claim 16, wherein said first web service session comprises a cloud storage service, and wherein said first modifiable component comprises an upload link to a cloud storage server used for upload, the cloud storage server having a geographical location associated therewith, and wherein said user interaction comprises initiating upload to the cloud storage server and wherein said first location-indicating parameter is based, at least in part, on the geographical location of the cloud storage server.

24. The server of claim 16, wherein said first web service session comprises a web site, the website having a content portion associated with a geographical location, and wherein said first location-indicating parameter is based, at least in part, on the geographical location associated with the content portion of the site.

25. The server of claim 16, wherein said first web service session comprises a weather forecast service and wherein said determining the first location-indicating parameter is based on a geographical location of the weather forecast for a region being viewed by the user.

26. The server of claim 16, wherein said first web service session comprises a web search service and wherein said determining the first location-indicating parameter is based on a geographical location associated with a web search query, the web search query is requested by the user.

27. The server of claim 16, wherein said first web service session comprises a delivery service and wherein said determining the first location-indicating parameter is based on a geographical location of the delivery request being booked by the user.
